(19) United States
(12) Patent Application Publication
(10) Pub. No.: US 2025/0145210 A1
(43) Pub. Date: May 8, 2025

(54) STEERING GEAR AND STEER-BY-WIRE STEERING DEVICE WITH SUCH A STEERING GEAR

(71) Applicant: ZF Automotive Germany GmbH, Alfdorf (DE)

(72) Inventor: Alexander WIERTZ, SOLINGEN (DE)

(21) Appl. No.: 18/941,016

(22) Filed: Nov. 8, 2024

(30) Foreign Application Priority Data
Nov. 8, 2023 (DE) 10 2023 211 073.3

(51) Int. Cl. B62D 5/04

(52) U.S. Cl. CPC B62D 5/0409; B62D 5/0406; B62D 5/0442

(57) ABSTRACT

The invention relates to a steering gear (1) for a steer-by-wire steering device for a vehicle and with a steering rod (4), wherein the steering rod (4) is connected to an electric drive (2) by means of a transmission device (3). In order to be able to better detect the forces acting on the steering rod (4), the steering gear (1) is characterized in that a bearing device (12) is arranged between the steering rod housing (11) and a steering rod portion (13) of the steering rod (4), wherein the bearing device (12) is fixedly attached or held on the steering rod housing (11), and the steering rod portion (13) and the bearing device (12) engage with one another in such a way that a rotational movement of the steering rod (4) is blocked and a translational displacement of the steering rod (4) in the axial direction of the central longitudinal axis (5) of the steering rod (4) is allowed, wherein a sensor device (29) for determining a torque of the steering rod (4) about the central longitudinal axis (5) of the steering rod (4) is arranged in the region of the bearing device (12).

### TECHNICAL FIELD

The invention relates to a steering gear for a steer-by-wire steering device and with a steering rod, wherein the steering rod is connected to an electric drive by means of a transmission device, and the transmission device is designed to convert a rotational movement of the electric drive into a translational movement of the steering rod in the axial direction of a central longitudinal axis of the steering rod, and with a steering rod housing in which the steering rod is partially arranged. Furthermore, the invention relates to a steer-by-wire steering device with such a steering gear.

BACKGROUND

### Such a steering gear and such a steer-by-wire steering device are known from DE 10 2023 200 999 A1.

A steer-by-wire steering device has no mechanical connection between the steering handle or steering wheel and the vehicle wheels, which is why such steering systems have a simulator unit to give the driver feedback. The simulator unit simulates the steering forces occurring at the steered vehicle wheel and thus gives the driver an impression of the steering condition. For this purpose, the simulator unit has a feedback drive which is attached to a steering shaft, which in turn is connected to the steering wheel. The forces transmitted to the steering wheel via the feedback drive are controlled by a control device. In order to achieve the best possible simulation of the forces ultimately acting on the steering wheel, it is desirable that the forces and/or torques acting in the area and/or on the steering rod can be measured or determined so that the control device can control the feedback drive on the basis of these measurement data.

### SUMMARY

It is the object of the invention to further develop a steer-by-wire steering device of the type mentioned at the beginning in such a way that the forces and/or torques acting on the steering rod can be better detected. In particular, an alternative embodiment is to be provided.

The object of the invention is achieved with a steering gear according to claim 1 and/or with a steer-by-wire steering device according to claim 11. Preferred developments of the invention will be apparent from the dependent claims and the following description.

The steering gear is designed for a steer-by-wire steering device. In particular, the steering gear and/or the steer-by-wire steering device is designed for a vehicle, in particular a motor vehicle. The steering gear has a steering rod. In particular, the steering rod can be used to steer the wheels of a vehicle or motor vehicle. The steering rod is connected to an electric drive via a transmission device. The steering rod may have teeth in at least one region of the steering rod, via which the steering rod can be connected to the transmission device and the electric drive. Here, the transmission device is designed to convert a rotational movement of the electric drive into a translational movement of the steering rod in the axial direction of a central longitudinal axis of the steering rod. According to a further embodiment, the transmission device can have a ball screw drive. Preferably, the steering rod is displaceable in the longitudinal direction of the central longitudinal axis by means of the electric drive and the transmission device.

Furthermore, the steering gear has a steering rod housing in which the steering rod is partially arranged. In particular, the steering rod is slidably mounted in the steering rod housing. The steering rod can extend outwards from the steering rod housing at two opposite ends. The outer ends of the steering rod can each be connected, in particular by means of a tie rod, to a wheel carrier for a wheel to be steered. The transmission unit can be arranged completely or partially in the steering rod housing.

According to the invention, a bearing device is arranged between the steering rod housing and a steering rod portion of the steering rod, wherein the bearing device is fixedly attached or held to the steering rod housing. In particular, the bearing device is designed as a bearing bush and/or sleeve-like. The bearing device can be held and/or fastened to the steering rod housing in a form-fitting, force-fitting and/or material-fitting manner.

The steering rod portion and the bearing device engage with each other in such a way that a rotational movement of the steering rod, in particular about the central longitudinal axis of the steering rod, is blocked and a translational displacement or sliding of the steering rod in the axial direction of the central longitudinal axis of the steering rod is possible. Preferably, the steering rod can slide relative to the bearing device in the axial direction of the central longitudinal axis.

Furthermore, a sensor device for determining and/or detecting a force acting on the steering rod and/or a torque acting on the steering rod about the central longitudinal axis of the steering rod is arranged in the region of the bearing device.

The advantage here is that, on the one hand, the steering rod is blocked by means of the bearing device against rotation about the central longitudinal axis of the steering rod, while at the same time an axial displacement of the steering rod in the direction of the central longitudinal axis is possible, and, on the other hand, a force acting on the steering rod and/or a torque acting on the steering rod can be detected by means of the sensor device in the area of the bearing device and thus in spatial proximity to the steering rod. By means of the bearing device, an effective and inexpensive bearing of the steering rod for the transverse or linear displacement of the steering rod can be realized. Based on the measurement data detected in the area of the bearing device, the forces and/or torques acting on the steering rod can be determined, which are incorporated into the control of the feedback drive and can improve the steering feel.

The bearing device can be annular or ring-shaped. In particular, the bearing device has an outer circumferential side directed radially to the central longitudinal axis and an inner circumferential side. Here, the outer circumferential side is directed radially outwards to the central longitudinal axis and the inner circumferential side is directed radially inwards to the central longitudinal axis. In particular, the outer circumferential side of the bearing device faces the steering rod housing, preferably an inner side of the steering rod housing. Preferably, the inner circumferential side of the bearing device faces the steering rod portion, in particular an outer circumference of the steering rod portion. The inner circumferential side of the bearing device has a bearing device-side guide contour which interacts with a steering rod-side guide contour of the steering rod portion which is designed to correspond to this bearing device-side guide contour. In this case, an interlocking of the bearing device-side and steering rod-side guide contours causes a blocking of the rotational movement of the steering rod and allows the translational movement of the steering rod.

According to a further embodiment, the bearing device-side guide contour has a plurality of elevations and depressions alternating in the circumferential direction around the central longitudinal axis. Accordingly, the steering rod-side guide contour has further depressions and elevations on the steering rod side corresponding to the elevations and depressions on the bearing device side. Thus, a bearing device-side elevation can engage in a corresponding further depression on the steering rod side and a bearing device-side depression can engage in a further elevation on the steering rod side. In particular, the elevations on the bearing device side and the steering rod side extending in the axial direction to the central longitudinal axis are each designed as webs and the depressions on the bearing device side and the steering rod side are each designed as grooves extending in the axial direction to the central longitudinal axis. Preferably, the elevations and depressions on the bearing device side and the steering rod side extend in the axial direction or parallel to the central longitudinal axis.

According to a further development, the outer circumferential side of the bearing device has a bearing device-side holding contour, which interacts with a housing-side holding contour of the steering rod housing that is designed to correspond to the bearing device-side holding contour. In this case, an interlocking or interaction of the bearing device-side holding contour with the housing-side holding contour causes a positive locking of the bearing device on the steering rod housing. In particular, the housing-side holding contour is formed on an inner side of the steering rod housing. In addition to the positive connection, the bearing device-side holding contour and the housing-side holding contour can be connected to one another by means of a material-fitting and/or force-fitting connection.

The holding contour on the bearing bush side can have several projections and/or recesses alternating in the circumferential direction around the central longitudinal axis. Accordingly, the housing-side holding contour has further recesses and/or projections on the housing side corresponding to the projections and/or recesses on the bearing device side. Thus, a projection on the bearing device side can engage in a corresponding further recess on the housing side and a recess on the bearing device side can engage in a further projection on the housing side. In particular, the bearing device is fixed due to the interaction of the projections and/or recesses on the bearing device side with the further recesses and/or projections on the housing side for blocking a rotational movement about the central longitudinal axis.

According to a further embodiment, the bearing device-side holding contour has a ring portion that projects radially outwards to the central longitudinal axis. This ring portion is accommodated in a correspondingly designed ring receptacle of the housing-side holding contour. As a result, the bearing device is fixed, in particular additionally, to the steering rod housing in the axial direction of the central longitudinal axis.

According to a further development, the sensor device has at least one sensor element for measuring an acting force and/or an acting torque. If an acting force is measured, the acting torque can be determined based on this. In particular, the direction of rotation of the acting torque can be determined. Preferably, using the determined torque, a force acting on the steering rod in the axial direction to the central longitudinal axis can be determined. The sensor element can be designed as a piezoelectric sensor. Preferably, the sensor device has a plurality of sensor elements. In particular, a direction or directional components of the acting force and/or the acting torque can be detected by means of several differently aligned sensor elements. The sensor device can have several similar and/or different sensor elements. For example, in addition to at least one force and/or torque sensor, a position sensor for determining a relative position of the steering rod in relation to the steering rod housing and/or a moisture sensor for sensing penetrating moisture can be provided.

The at least one sensor element can be arranged on or in the bearing device. Thus, the at least one sensor element can be an integral part of the bearing device itself. In this case, the at least one sensor element can be completely or partially enclosed by the material of the bearing device. The material of the bearing device can be a plastic material. In particular, the at least one sensor element is arranged in a projection on the bearing device side which is supported in the circumferential direction around the central longitudinal axis on the steering rod housing. In this case, the projection on the bearing device side with the sensor element can be supported on a further projection on the housing side in the direction of rotation about the central longitudinal axis. This makes it particularly easy to detect and/or determine the torque acting on the steering rod.

Alternatively, the sensor element can be arranged in a bearing device-side elevation that is supported on the steering rod in the circumferential direction around the central longitudinal axis. In this case, the elevation on the bearing device side with the sensor element can be supported on a further elevation on the steering rod side in the direction of rotation about the central longitudinal axis. This makes it particularly easy to detect and/or determine the torque acting on the steering rod.

According to a further alternative embodiment, the at least one sensor element is arranged and/or accommodated on or in the steering rod housing. In this case, the at least one sensor element can be completely or partially enclosed by the material of the steering rod housing. The material of the steering rod housing can be metal or a plastic material. In particular, the at least one sensor element is arranged in a projection on the housing side which is supported in the circumferential direction around the central longitudinal axis on the bearing device. In this case, the projection on the housing side with the sensor element can be supported on a further projection on the steering rod side in the direction of rotation about the central longitudinal axis, whereby a torque acting on the steering rod can be particularly well detected and/or determined.

According to a further development, the sensor device has a plurality of sensor elements, wherein the plurality of sensor elements form a first set of first sensor elements and a second set of second sensor elements. Here, the first sensor elements are designed and/or arranged such that the first sensor elements measure the force and/or the torque in relation to a first direction of rotation about the central longitudinal axis of the steering rod. The second sensor elements are designed and/or arranged such that the second sensor elements measure the force and/or the torque in relation to a second direction of rotation about the central longitudinal axis that is opposite to the first direction of rotation.

Preferably, a force acting on the steering rod in the circumferential direction about the central longitudinal axis and/or in the axial direction of the central longitudinal axis can be determined by means of the sensor device and/or the data measured by means of the sensor device, in particular relative to an acting force and/or an acting torque. Preferably, these data and/or certain forces and/or torques are used and/or further processed in order to be able to provide a vehicle driver with an improved steering feel on the steering handle, in particular by means of the feedback drive.

A steer-by-wire steering device with a steering gear according to the invention is particularly advantageous. The steer-by-wire steering device may include a steering wheel. The term steering wheel is a synonym for a steering handle of any shape and/or form. In particular, the steering device has a steering shaft. Preferably, the steering shaft is rotatable or rotatably mounted about its central longitudinal axis. The steering shaft can rotate around the central longitudinal axis in two opposite directions. The steering wheel can be located at one end of the steering shaft. The steer-by-wire steering device may include a feedback drive. In this case, the steering shaft can be set into a rotational movement about the central longitudinal axis of the steering shaft by means of the feedback drive, in particular with the interposition of a transmission, and/or provide a controllable torque resistance. This provides the driver of a vehicle or motor vehicle with such a steering device with a feedback regarding the steering forces acting on the wheels. In particular, the feedback drive is designed as an electric motor. The feedback drive can be arranged at an end of the steering shaft facing away from the steering wheel. Preferably, the steer-by-wire steering device is further developed according to the embodiments explained in connection with the steering gear according to the invention described here.

### BRIEF DESCRIPTION OF THE DRAWINGS

The invention is explained in more detail below with reference to the figures. The same reference symbols refer to the same, similar or functionally identical components or elements. In the figures:

FIG. 1 shows a sectional schematic side view of a steering gear according to the invention,

FIG. 2 shows a section of a perspective, partially transparent view of the steering gear according to the invention according to FIG. 1,

FIG. 3 shows a perspective first view of a bearing bush for the steering gear according to the invention according to FIGS. 1 and 2, and

FIG. 4 shows a further perspective view of the bearing bush for the steering gear according to the invention according to FIGS. 1 and 2.

### DESCRIPTION

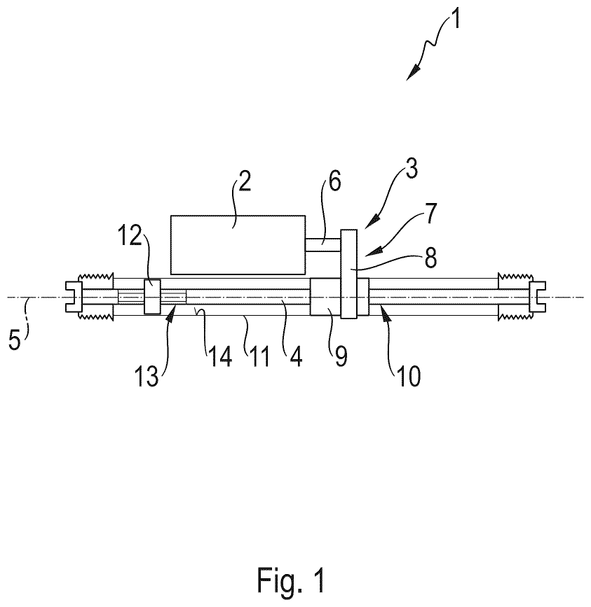

FIG. 1 shows a sectional, schematic side view of a steering gear 1 according to the invention. In this exemplary embodiment, the steering gear 1 is a component of a steer-by-wire steering device (not shown in detail) for steering a motor vehicle. Due to this design, there is thus no mechanical connection between the steering gear 1 for steering wheels (not shown in detail here) and a steering handle (also not shown in detail here), such as a steering wheel.

The steering gear 1 has a drive 2, which is designed here as an electric drive or electric motor. The drive 2 is connected to a steering rod 4 by means of a transmission device 3. Here, the transmission device 3 is designed to convert a rotational movement of the electric drive 2 into a translational movement of the steering rod 4 in the axial direction of a central longitudinal axis 5 of the steering rod 4.

In this exemplary embodiment, the drive 2 is connected by means of a drive shaft 6 to a transmission 7, which is implemented here as a belt transmission by way of example. Accordingly, the transmission 7 here has a belt 8.

The transmission device 3 or transmission 7 has a spindle nut element 9 which, according to this example, can be driven by means of the belt 8. The spindle nut element 9 is rotatably mounted about the central longitudinal axis 5 of the steering rod 4 by means of the drive 2.

For this purpose, the spindle nut element 6 is in engagement with a spindle portion 10 of the steering rod 4. In detail, an inner circumference of the spindle nut element 9 interacts with an outer circumference of the spindle portion 10. In this exemplary embodiment, the spindle nut element 9 interacts with the spindle portion 10 by means of a ball screw drive (not shown in detail here). A displacement of the spindle nut element 9 is blocked in the longitudinal direction of the steering rod 4. At the same time, a twisting or rotation of the steering rod 4 about its central longitudinal axis 5 is blocked, as explained in more detail below. Thus, the steering rod 4 can be displaced in the longitudinal direction or in the axial direction of the central longitudinal axis 5 due to a rotation of the spindle nut element 9.

The steering rod 4 extends outwards from a steering rod housing 11 at two opposite ends. Thus, the steering rod 4 is partially arranged within the steering rod housing 11. By means of the steering rod 4, wheels of a vehicle or motor vehicle (not shown in detail here) can be steered. In this embodiment, the transmission device 3 is at least partially arranged outside the steering rod housing 11. Alternatively, the steering rod housing 11 can be designed such that the transmission device 3 is arranged within the steering rod housing 11.

The steering device 1 has a bearing device 12 for the steering rod 4. The bearing device 12 is arranged between the steering rod housing 11 and a steering rod portion 13 of the steering rod 4. Here, the bearing device 12 is fixedly attached to the steering rod housing 11 or to an inner side 14 of the steering rod housing 11.

As explained in more detail below, the steering rod portion 13 and the bearing device 12 engage with each other in such a way that a rotational movement of the steering rod 4 is blocked and a translational or linear displacement of the steering rod 4 in the axial direction of the central longitudinal axis 5 is possible.

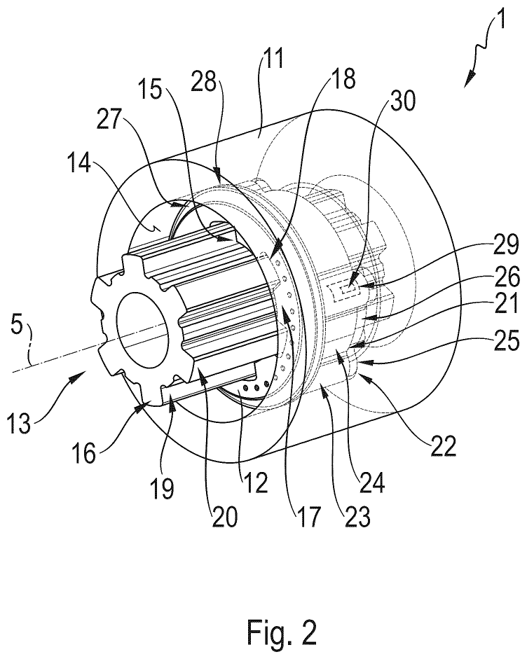

FIG. 2 shows a section of a perspective, partially transparent view of the steering gear 1 according to the invention according to FIG. 1. A section of the area of the steering rod 4 according to FIG. 1 with the steering rod portion 13 and the bearing device 12 can be seen.

In this embodiment, the bearing device 12 is designed as a bearing bush and thus sleeve-like or ring-like.

The bearing device 12 has a bearing device-side guide contour 15, which interacts with a steering rod-side guide contour 16 of the steering rod portion 13, which corresponds to the bearing device-side guide contour 15, for blocking the rotational movement and allowing the translational movement of the steering rod 4.

The bearing device-side guide contour 15 has a plurality of elevations 17 and depressions 18 alternating in the circumferential direction around the central longitudinal axis 5.

Accordingly, the steering rod-side guide contour 16 has further steering rod-side depressions 19 and elevations 20 corresponding to the bearing device-side elevations 17 and depressions 18. For the sake of better clarity, not all elevations 17, 20 and depressions 18, 19 are provided with a reference numeral.

In this embodiment, the bearing device-side and steering rod-side elevations 17, 20 are designed as webs and the bearing device-side and steering rod-side depressions 18, 20 are designed as grooves, wherein the bearing device-side and steering rod-side elevations 17, 20 and depressions 18, 20 extend in the axial direction or parallel to the central longitudinal axis 5. Furthermore, the elevations 17, 20 and depressions 18, 20 extend radially to the central longitudinal axis 5, wherein, for example, the elevations 17 extend radially inwards and the elevations 20 extend radially outwards.

Furthermore, the bearing device 12 has a bearing device-side holding contour 21. The bearing device-side holding contour 21 interacts with a housing-side holding contour 22 of the steering rod housing 11, which is designed to correspond to the bearing device-side holding contour 21, for fixing the bearing device 12 to the steering rod housing 11. For this purpose, the housing-side holding contour 22 is formed on the inner side 14 of the steering rod housing 11.

In this embodiment, the bearing bush-side holding contour 21 has a plurality of projections 23 and recesses 24 alternating in the circumferential direction around the central longitudinal axis 5. The housing-side holding contour 22 has, corresponding to the bearing device-side projections 23 and recesses 24, further housing-side recesses 25 and projections 26. For the sake of better clarity, not all projections 23, 26 and recesses 24, 25 are provided with a reference numeral. The projections 23, 26 and recesses 24, 25 extend radially to the central longitudinal axis 5, wherein, for example, the projections 23 extend radially outwards and the projections 26 extend radially inwards.

The bearing device 12 is fixed due to the interaction of the bearing device-side projections 23 and recesses 24 with the further recesses 25 and projections 26 on the housing side for blocking a rotational movement about the central longitudinal axis 5.

Furthermore, in this exemplary embodiment, the bearing device-side holding contour 21 of the bearing device 12 is inserted and fixed in a form-fitting manner axially to the central longitudinal axis 5 in the housing-side holding contour 22, for example by means of an additional force and/or material connection between the bearing device-side holding contour 21 and the housing-side holding contour 22.

In this embodiment, the bearing device-side holding contour 21 has a ring portion 27 that projects radially outwards to the central longitudinal axis 5. This ring portion 27 is received in a correspondingly designed ring receptacle 28 of the housing-side holding contour 22. As a result, the bearing device 12 is fixed to the steering rod housing 11 in the axial direction of the central longitudinal axis 5.

The steering device 1 has a sensor device 29 for determining a torque of the steering rod 4 about the central longitudinal axis 5 in the region of the bearing device 12. The sensor device 29 is only indicated schematically here.

In this exemplary embodiment, the sensor device 29 has a sensor element 30 for measuring an acting force or an acting torque. Here, the sensor element 30 is designed as a piezoelectric sensor, for example. Alternatively, the sensor device 29 can have multiple sensor elements 30.

Furthermore, in this exemplary embodiment, the sensor element 30 is arranged in the bearing device 12 or embedded in the material of the bearing device 12. According to this example, the sensor element 30 is arranged in a bearing device-side projection 23 which is supported on the steering rod housing 11 in the circumferential direction about the central longitudinal axis 5. The sensor device 19 or the sensor element 30 is connected to a control device in a manner not shown in detail here.

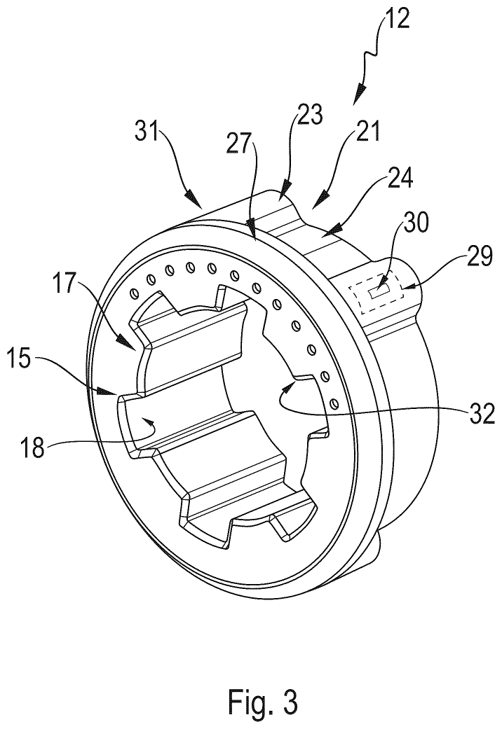

FIG. 3 shows a perspective first view of the bearing device 12 for the steering gear 1 according to the invention according to FIGS. 1 and 2. The same features have the same reference numerals as before. In order to avoid repetition, reference is also made to the preceding description.

The bearing device 12 has an outer circumferential side 31 directed radially outwards to the central longitudinal axis 5 and an inner circumferential side 32 directed radially inwards to the central longitudinal axis 5. The bearing device-side holding contour 21 is formed on the outer circumferential side 31 and the bearing device-side guide contour 15 is formed on the inner circumferential side 32.

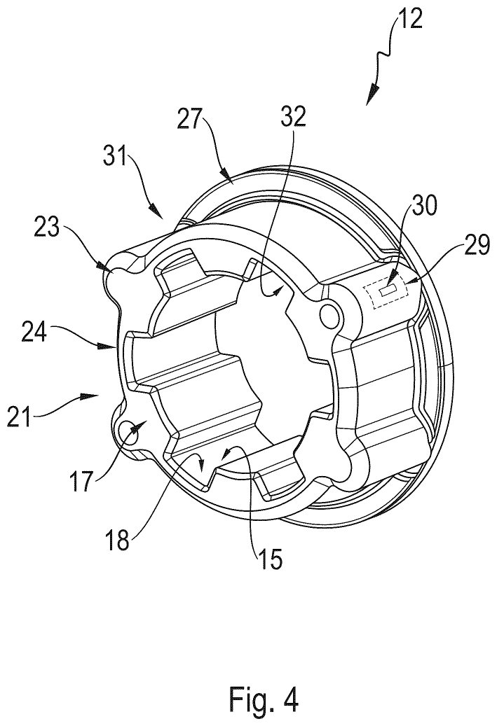

FIG. 4 shows a perspective further view of the bearing device 12 for the steering gear 1 according to the invention according to FIGS. 1 and 2. The same features bear the same reference numerals as before. In order to avoid repetition, reference is also made to the preceding description.

### REFERENCE NUMERALS

1 steering gear
2 drive
3 transmission device
4 steering rod
5 central longitudinal axis
6 drive shaft
7 transmission
8 belt
9 spindle nut element
10 spindle portion
11 steering rod housing
12 bearing device
13 steering rod portion
14 inner side
15 bearing device-side guide contour
16 housing-side guide contour
17 elevation
18 depression
19 further depression
20 further elevation
21 bearing device-side holding contour
22 housing-side holding contour
23 projection
24 recess
25 further recess
26 further projection
27 ring portion
28 ring holder
29 sensor device
30 sensor element
31 outer circumferential side
32 inner circumferential side

1. A steering gear for a steer-by-wire steering device and with a steering rod (4), wherein the steering rod (4) is connected to an electric drive (2) by means of a transmission device (3), and the transmission device (3) is designed to convert a rotational movement of the electric drive (2) into a translational movement of the steering rod (4) in the axial direction of a central longitudinal axis (5) of the steering rod (4), and with a steering rod housing (11) in which the steering rod (4) is partially arranged, wherein a bearing device (12) is arranged between the steering rod housing (11) and a steering rod portion (13) of the steering rod (4), wherein the bearing device (12) is fixedly attached or held on the steering rod housing (11), and the steering rod portion (13) and the bearing device (12) engage in one another in such a way that a rotational movement of the steering rod (4) is blocked and a translational displacement of the steering rod (4) in the axial direction of the central longitudinal axis (5) of the steering rod (4) is allowed, wherein a sensor device (29) for determining a force and/or a torque of the steering rod (4) about the central longitudinal axis (5) of the steering rod (4) is arranged in the region of the bearing device (12).

2. The steering gear according to claim 1, wherein the bearing device (12) is of annular or ring-like shape and/or the bearing device (12) has an outer circumferential side (31) directed radially to the central longitudinal axis (5) and an inner circumferential side (32), wherein the inner circumferential side (32) has a bearing device-side guide contour (15) which cooperates with a steering rod-side guide contour (16) of the steering rod portion (13) designed to correspond to the bearing device-side guide contour (15) for blocking the rotational movement and allowing the translational movement of the steering rod (4).

3. The steering gear according to claim 2, wherein the bearing device-side guide contour (15) has a plurality of elevations (17) and depressions (18) alternating in the circumferential direction around the central longitudinal axis (5), wherein the steering rod-side guide contour (16) has further steering rod-side depressions (19) and elevations (18) corresponding to the bearing device-side elevations (17) and depressions (18), in particular the bearing device-side and steering rod-side elevations (17, 20) are designed as webs and the bearing device-side and steering rod-side depressions (18, 19) are designed as grooves, preferably the bearing device-side and steering rod-side elevations (17, 20) and depressions (18, 19) extend in the axial direction and/or parallel to the central longitudinal axis (5).

4. The steering gear according to claim 2, wherein the outer circumferential side (31) of the bearing device (12) has a bearing device-side holding contour (21) which cooperates with a housing-side holding contour (22) of the steering rod housing (11) designed to correspond to the bearing device-side holding contour (21) for fixing the bearing device (12) to the steering rod housing (11), in particular the housing-side holding contour (22) is formed on an inner side (14) of the steering rod housing (11).

5. The steering gear according to claim 4, wherein the holding contour (21) on the bearing bush side has a plurality of projections (23) and/or recesses (24) alternating in the circumferential direction around the central longitudinal axis (5), wherein the housing-side holding contour (22) has further recesses (25) and/or further housing-side projections (26) corresponding to the bearing device-side projections (23) and/or recesses (24), in particular the bearing device (12) is fixed due to the interaction of the bearing device-side projections (23) and/or recesses (24) with the further housing-side recesses (25) and/or projections (26) for blocking a rotational movement around the central longitudinal axis (5).

6. The steering gear according to claim 4, wherein the bearing device-side holding contour (21) has a ring portion (27) projecting radially outwards to the central longitudinal axis (5), wherein the ring portion (27) is received in a correspondingly designed ring receptacle (28) of the housing-side holding contour (22), whereby the bearing device (12) is fixed to the steering rod housing (11) in the axial direction of the central longitudinal axis (5).

7. The steering gear according to claim 1, wherein the sensor device (29) has at least one sensor element (30) for measuring the acting force and/or the acting torque, in particular the sensor element (30) is designed as a piezoelectric sensor.

8. The steering gear according to claim 7, wherein the at least one sensor element (30) is arranged on or in the bearing device (12), in particular the at least one sensor element (30) is arranged in a bearing device-side projection (23) supported in the circumferential direction about the central longitudinal axis (5) on the steering rod housing (11) or in a bearing device-side elevation (17) supported in the circumferential direction about the central longitudinal axis (5) on the steering rod (4).

9. The steering gear according to claim 7, wherein the at least one sensor element (30) is arranged on or in the steering rod housing (11), in particular the at least one sensor element (30) is arranged in a housing-side projection (26) which is supported in the circumferential direction about the central longitudinal axis (5) on the bearing device (12).

10. The steering gear according to claim 1, wherein the sensor device (29) has a plurality of sensor elements (30), wherein the plurality of sensor elements (30) form a first set of first sensor elements (30) and a second set of second sensor elements (30), and the first sensor elements (30) measure the force and/or the torque in relation to a first direction of rotation about the central longitudinal axis and the second sensor elements (30) measure the force and/or the torque in relation to a second direction of rotation about the central longitudinal axis opposite to the first direction of rotation.

11. The steering gear according to claim 1, wherein a force acting on the steering rod (4) in the circumferential direction about the central longitudinal axis (5) and/or in the axial direction of the central longitudinal axis (5) can be determined by means of the sensor device (29) and/or the data measured by means of the sensor device (29).

12. A steer-by-wire steering device with a steering gear (1) according to claim 1.
